(19) United States
(12) Patent Application Publication
(10) Pub. No.: US 2025/0313109 A1
(43) Pub. Date: Oct. 9, 2025

(54) ELECTRIFIED VEHICLE

(71) Applicant: TOYOTA JIDOSHA KABUSHIKI KAISHA, Toyota-shi (JP)

(72) Inventors: Ayumu YAGETA, Nisshin-shi (JP); Masaru KIMURA, Toyota-shi (JP)

(73) Assignee: TOYOTA JIDOSHA KABUSHIKI KAISHA, Toyota-shi (JP)

(21) Appl. No.: 19/087,743

(22) Filed: Mar. 24, 2025

(30) Foreign Application Priority Data
Apr. 3, 2024 (JP) 2024-060220

(51) Int. Cl. B60L 53/54; B60L 53/57

(52) U.S. Cl. CPC B60L 53/54; B60L 53/57; B60L 2270/20

(57) ABSTRACT

Electrified vehicle includes an in-vehicle charger for performing external power feeding, an operation unit operated by the user at the time of power feeding, a switching unit that connects the in-vehicle charger and the in-vehicle battery by the operation unit being in contact, and a regulating unit that restricts contact between the operation unit and the switching unit when the first relay mechanism used for the operation of the high-voltage system of electrified vehicle is connected.

### CROSS-REFERENCE TO RELATED APPLICATION

This application claims priority to Japanese Patent Application No. 2024-060220 filed on Apr. 3, 2024, incorporated herein by reference in its entirety.

### BACKGROUND

### 1. Technical Field

The present disclosure relates to an electrified vehicle.

### 2. Description of Related Art

Japanese Unexamined Patent Application Publication No. 2018-069832 (JP 2018-069832 A) discloses an electrified vehicle including a changeover switch for starting external power feeding.

### SUMMARY

When connection between an in-vehicle battery and an in-vehicle charger is switched by the changeover switch as described in JP 2018-069832 A, and the changeover switch is operated while a relay mechanism on the vehicle side is in an on state, there is a possibility that a great current will momentarily flow through the in-vehicle charger.

The present disclosure provides an electrified vehicle that is capable of suppressing a great current from momentarily flowing through an in-vehicle charger.

An electrified vehicle according to the present disclosure, includes an in-vehicle charger for performing power feeding externally, an operation unit that is operated by a user at a time of power feeding, a switching unit that connects the in-vehicle charger and an in-vehicle battery by the operation unit coming into contact, and a regulating unit that regulates contact between the operation unit and the switching unit when a first relay mechanism used for operation of a high-voltage system of the electrified vehicle is connected.

According to the present disclosure, a great current can be suppressed from momentarily flowing through the in-vehicle charger by providing the regulating unit that regulates contact (connection) between the operation unit and the switching unit when the first relay mechanism is on (when connected).

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of circuitry including an in-vehicle battery and an in-vehicle charger in an electrified vehicle according to an embodiment;

FIG. 2 is a schematic diagram illustrating an operation of the regulating unit when the second relay mechanism is on in electrified vehicle according to the embodiment; and

FIG. 3 is a schematic diagram illustrating an operation of the regulating unit when the second relay mechanism is off in electrified vehicle according to the embodiment.

### DETAILED DESCRIPTION OF EMBODIMENTS

An electrified vehicle according to an embodiment of the present disclosure will be described referring to the drawings. Incidentally, the constituent elements in the following embodiments include those that can be easily replaced by a person skilled in the art or those that are substantially the same.

Electrified vehicle according to the embodiment is, for example, fuel cell electric vehicle (FCEV). In this electrified vehicle, electric power generated by the host vehicle is supplied to an external electrified vehicle through an in-vehicle charger. Electrified vehicle is, for example, battery electric vehicle (BEV). Thus, in electrified vehicle, the rescue charge can be performed for electrified vehicle of the power shortage.

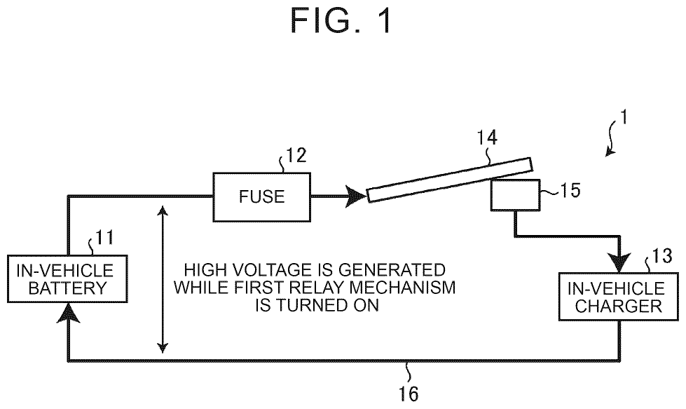

As illustrated in FIG. 1, electrified vehicle 1 includes an in-vehicle battery 11, a fuse 12, an in-vehicle charger 13, an operation unit 14, a switching unit 15, and a power cable 16. It should be noted that FIG. 1 illustrates only a configuration required for realizing the present disclosure among actual configurations of electrified vehicle 1, and omits illustration of another configuration (for example, inverters, motors, and the like).

The in-vehicle battery 11 is, for example, a fuel cell (FC). Electrified vehicle 1 may include, as the in-vehicle battery 11, a cell other than a fuel cell (for example, any cell other than a fuel cell, such as a lithium-ion battery, an all-solid-state battery, a nickel metal hydride battery, or a lead-acid battery). The fuse 12 is connected to the in-vehicle battery 11, and shuts off the circuit when a large current momentarily flows through a circuit including the in-vehicle battery 11 and the in-vehicle charger 13.

The in-vehicle charger 13 is mounted on an electrified vehicle 1, and performs power feeding (external power feeding) to an external electrified vehicle, for example.

The operation unit 14 is a changeover switch for performing external power feeding. The operation unit 14 is operated by a user (for example, a driver) of electrified vehicle 1 when power feeding is performed from the in-vehicle charger 13 to an external electrified vehicle. For example, a switch, a button, or the like corresponding to the operation unit 14 is provided in the vehicle cabin of electrified vehicle 1. When the user presses the switch or the like, the operation unit 14 performs an operation of approaching the switching unit 15.

The switching unit 15 electrically connects the in-vehicle charger 13 and the in-vehicle battery 11 when the operation unit 14 is in contact with each other. In addition, when the operation unit 14 is not in contact, the switching unit 15 releases the electrical connection between the in-vehicle charger 13 and the in-vehicle battery 11.

The power cable 16 is for connecting the in-vehicle battery 11, the fuse 12, the in-vehicle charger 13, the operation unit 14, and the switching unit 15. Note that, in FIG. 1, an arrow indicated on the power cable 16 indicates a direction of a current flowing through the power cable 16.

Here, electrified vehicle 1 is provided with a first relay mechanism (not shown). The first relay mechanism is a relay used for operating a high-voltage system (for example, a system of a drive system such as a motor) in electrified vehicle 1 by using electric power of the in-vehicle battery 11.

Examples of the first relay mechanism include a relay provided between the fuel cell and the high-voltage system in electrified vehicle 1 and configured to turn on/off a current therebetween.

When the first relay mechanism is on (connected), a high voltage is generated in the power cable 16. Therefore, as shown in FIG. 1, when the user operates the operation unit 14 and brings the operation unit 14 and the switching unit 15 into contact with each other in this state, a large current momentarily flows from the in-vehicle battery 11 to the in-vehicle charger 13, and the fuse 12 is disconnected.

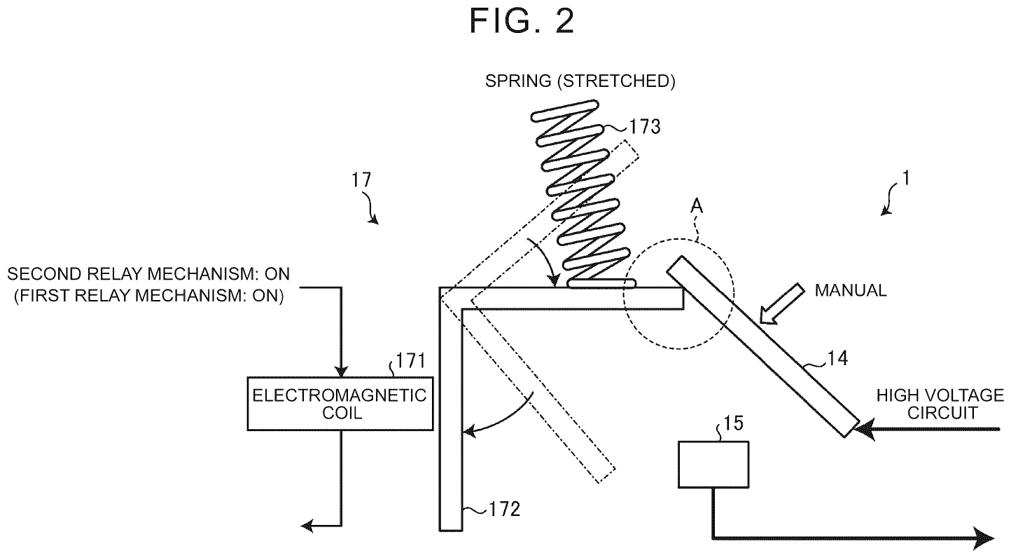

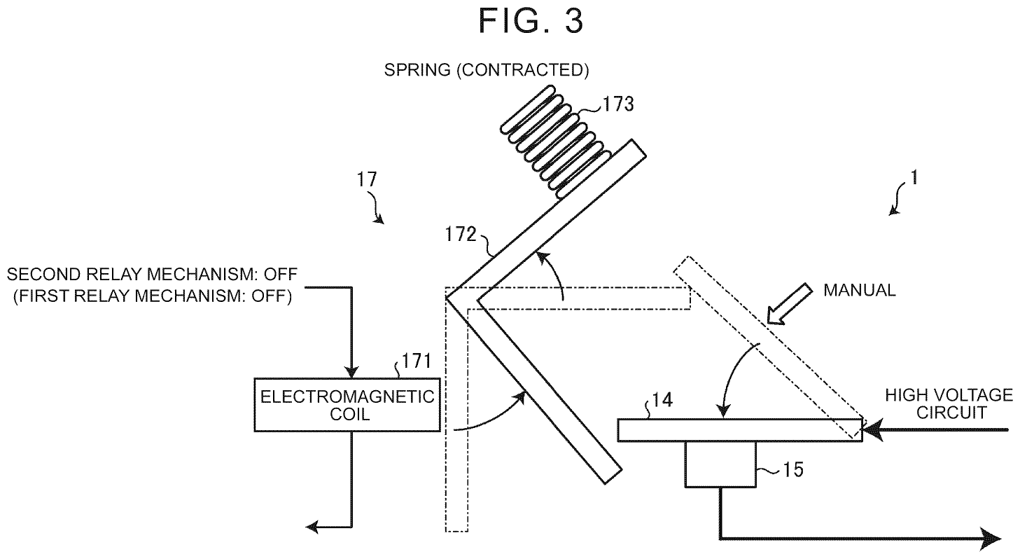

In electrified vehicle 1, as shown in FIGS. 2 and 3, a regulating unit 17 is provided between the operation unit 14 and the switching unit 15 in order to prevent the operation unit 14 and the switching unit 15 from physically contacting each other when a high voltage is generated.

The regulating unit 17 restricts the contact between the operation unit 14 and the switching unit 15 when the first relay mechanism is on (connected). The regulating unit 17 includes an electromagnetic coil 171, a moving unit 172, and an elastic member 173.

The electromagnetic coil 171 operates according to the status of the second relay mechanism of electrified vehicle 1. That is, when the second relay mechanism is on (connected), the electromagnetic coil 171 is in an energized state. On the other hand, when the second relay mechanism is off (disconnected), the electromagnetic coil 171 is in a non-energized state.

The second relay mechanism is a relay used when operating a low-voltage system (e.g., an electrical system such as an air conditioner) in electrified vehicle 1. The second relay mechanism is interlocked with the first relay mechanism only in the off state. That is, when the second relay mechanism is on, the first relay mechanism is either on or off. On the other hand, when the second relay mechanism is off, the first relay mechanism is always in the off state.

The moving unit 172 is, for example, a metal block bar that restricts contact between the operation unit 14 and the switching unit 15 under a predetermined condition. The moving unit 172 is configured in an L-shape as shown in FIG. 2, for example. However, the material and shape of the moving unit 172 are not particularly limited as long as the function and operation of the moving unit 172 can be realized.

An elastic member 173 is attached to one side of the moving unit 172. An electromagnetic coil 171 is disposed on the other side of the moving unit 172. As illustrated in FIGS. 2 and 3, the moving unit 172 is configured to be able to move closer to and away from the electromagnetic coil 171.

The elastic member 173 is for pulling the moving unit 172 toward the side opposite to the side where the electromagnetic coil 171 is disposed. As the elastic member 173, for example, a spring as shown in FIGS. 2 and 3 can be used. Further, the elastic member 173 is constituted by a member having an elastic force smaller than a force attracted by electromagnetic induction of the electromagnetic coil 171 in an energized state.

In electrified vehicle 1 including the regulating unit 17, the second relay mechanism is turned on, and the electromagnetic coil 171 is energized. Then, as shown in FIG. 2, the moving unit 172 is attracted toward the electromagnetic coil 171 by electromagnetic induction. As a result, even if the user manually operates the operation unit 14, the operation unit 14 comes into contact with the moving unit 172 (in a state of being in contact with the moving unit), so that the contact between the operation unit 14 and the 15 switching unit 15 is restricted.

If the second relay mechanism is on as shown in FIG. 2, the first relay mechanism may also be on. Therefore, when the second relay mechanism is on, by uniformly regulating the contact between the operation unit 14 and the switching unit 15 by the regulating unit 17, it is possible to more reliably suppress the inflow of a large current. 20

In addition, in electrified vehicle 1, the second relay mechanism is turned off, and the electromagnetic coil 171 is not energized. Then, as shown in FIG. 3, the moving unit 172 returns to its original position on the opposite side of the electromagnetic coil 171 by the contraction force of the elastic member 173. Accordingly, when the user manually operates the operation unit 14, the operation unit 14 can be brought into contact with the 25 switching unit 15 without being obstructed by the regulating unit 17, so that external power feeding can be performed from the in-vehicle charger 13.

As shown in FIG. 3, when the second relay mechanism is off, the first relay mechanism is always off. Therefore, when the second relay mechanism is off, the external power feeding can be safely performed while suppressing the inflow of a large current by not restricting the second relay mechanism by the regulating unit 17.

In FIGS. 2 and 3, the regulating unit 17 is operated in accordance with the state of the second relay mechanism. However, if it is possible to determine whether or not a high voltage is generated, the regulating unit 17 may be operated by means other than the state of the second relay mechanism.

According to electrified vehicle of the above-described embodiment, the regulating unit 17 restricts the contact (connection) between the operation unit 14 and the switching unit 15 when the first relay mechanism is on (connected). As a result, it is possible to suppress a large current from momentarily flowing through the in-vehicle charger 13. Further, according to electrified vehicle of the embodiment, the moving unit 172 is operated by using the electromagnetic coil 171 that is energized when the second relay mechanism is on. As a result, it is possible to suppress a large current from instantaneously flowing through the in-vehicle charger 13 without newly using an expensive breakdown voltage element.

Further advantages and variations can be readily derived by one of ordinary skill in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. An electrified vehicle, comprising:
an in-vehicle charger for performing power feeding externally;
an operation unit that is operated by a user at a time of power feeding;
a switching unit that connects the in-vehicle charger and an in-vehicle battery by the operation unit coming into contact; and
a regulating unit that regulates contact between the operation unit and the switching unit when a first relay mechanism used for operation of a high-voltage system of electrified vehicle is connected.

2. The electrified vehicle according to claim 1, wherein
the regulating unit includes
an electromagnetic coil to which electricity is applied when a second relay mechanism used for operation of a low-voltage system of the electrified vehicle is on, and
a moving unit that regulates contact between the operation unit and the switching unit when electricity is applied to the electromagnetic coil, and does not regulate contact between the operation unit and the switching unit when electricity is not applied to the electromagnetic coil.
